(19) United States
(12) Patent Application Publication
(10) Pub. No.: US 2024/0345230 A1
(43) Pub. Date: Oct. 17, 2024

(54) LIDAR AND OPTICAL CHIP

(71) Applicant: Wuhan VanJee Optoelectronic Technology Co., Ltd., Wuhan (CN)

(72) Inventors: Lei ZHANG, Wuhan (CN); Yang XU, Wuhan (CN); Yongqiang DENG, Wuhan (CN)

(73) Assignee: Wuhan VanJee Optoelectronic Technology Co., Ltd., Wuhan (CN)

(21) Appl. No.: 18/756,133

(22) Filed: Jun. 27, 2024

Related U.S. Application Data
(63) Continuation-in-part of application No. PCT/CN2022/124129, filed on Oct. 9, 2022.

(30) Foreign Application Priority Data
Dec. 30, 2021 (CN) 202111682414.3

(51) Int. Cl. G01S 7/493; G01S 7/481

(52) U.S. Cl. CPC G01S 7/493; G01S 7/4814

(57) ABSTRACT

A lidar and an optical chip. The lidar includes a laser light source, a beam splitter, an optical transceiving unit, a coherent interference light rejection unit, a detection unit, and a signal processing unit. The laser signal is divided into a detection light signal and a local oscillator light signal which enters the coherent interference light rejection unit through the beam splitter, and the detection light signal is emitted to a detection space through the optical transceiving unit; besides, the optical transceiving unit receives an echo signal, and generates an interference light signal during transmitting the detection light signal. The echo signal and the interference light signal enter the coherent interference light rejection unit and are mixed with a phase-shifted local oscillator light signal to eliminate the interference light signal, generate a beat frequency signal and send the beat frequency signal to the signal processing unit.

### CROSS-REFERENCE TO RELATED APPLICATION

This application is a continuation-in-part of International Application No. PCT/CN2022/124129 filed on Oct. 9, 2022, which claims priority to Chinese Patent Application No. 202111682414.3, filed with the China National Intellectual Property Administration on Dec. 30, 2021 and entitled “COAXIAL TRANSCEIVING LIDAR AND OPTICAL CHIP”, both of the two applications are incorporated herein by reference in their entireties.

### TECHNICAL FIELD

The present application belongs to the technical field of lidar and, in particular, to a lidar and an optical chip.

### BACKGROUND

Frequency Modulated Continuous Wave (FMCW) lidar is capable of transmitting a laser signal with a linear frequency modulated (referred to as emitted light or detection light signal), and after receiving a laser signal reflected back from an obstacle (referred to as received light or echo signal), it determines a distance and other related information of the obstacle based on frequency difference between the detection light signal and the echo signal at the receiving moment. FMCW lidar has a high accuracy of distance measurement.

FMCW lidar includes parallel axis FMCW lidar and coaxial FMCW lidar. However, whether it is the parallel axis FMCW lidar or the coaxial FMCW lidar, the emitted light will produce a specific interference light signal in the lidar optical system. For example, for the coaxial FMCW lidar, the emitted detection light signal and the received echo signal have identical optical paths in an optical transceiving unit. Therefore, interference light signal caused by end-face reflection during transmission of the detection light signal may also be detected, and for parallel axis FMCW lidar, light in a transmitting optical path may enter a receiving optical path by the crosstalk, thereby forming interference light signal in the receiving optical path and being detected. Since FMCW lidar has extremely high detection sensitivity, if the emitted light produces interference light signal in the lidar optical system, the interference light signal will seriously interfere with the detection of an echo signal, resulting in an inaccurate lidar ranging, and even causing the lidar to fail to work.

### SUMMARY

Embodiments of the present application provide a lidar and an optical chip, which can eliminate, to a certain extent, an interference light signal generated in the lidar optical system, improve an accuracy of lidar ranging, and ensure a normal operation of the lidar.

In order to solve the above technical problems, embodiments of the present application provide the following technical solutions.

In a first aspect, an embodiment of the present application provides a lidar, including:
a laser light source, configured to generate a laser signal;
a beam splitter, configured to receive the laser signal and divide the laser signal into a detection light signal and a local oscillator light signal;
an optical transceiving unit, configured to receive the detection light signal provided by the beam splitter, transmit the detection light signal to a detection space, and receive an echo signal corresponding to the detection light signal, where the optical transceiving unit generates an interference light signal during transmission of the detection light signal;
a coherent interference light rejection unit, configured to perform phase shifting on the local oscillator light signal, and mix a phase-shifted local oscillator light signal, the echo signal, and the interference light signal, where coherent cancellation is performed on the phase-shifted local oscillator light signal and the interference light signal to eliminate the interference light signal, and frequency beating is performed on the local oscillator light signal after the coherent cancellation and the echo signal to generate a beat frequency signal;
a detection unit, configured to receive the beat frequency signal provided by the coherent interference light rejection unit, and convert the beat frequency signal into an electrical signal; and
a signal processing unit, connected to the detection unit, and configured to determine related information of an obstacle according to the electrical signal.

In a second aspect, an embodiment of the present application provides an optical chip, including:
a beam splitter, configured to receive a laser signal and divide the laser signal into a detection light signal and a local oscillator light signal;
an optical transceiving unit, configured to receive the detection light signal provided by the beam splitter, transmit the detection light signal to a detection space, and receive an echo signal corresponding to the detection light signal, where the optical transceiving unit generates an interference light signal during transmission of the detection light signal;
a coherent interference light rejection unit, configured to perform phase shifting on the local oscillator light signal, and mix a phase-shifted local oscillator light signal, the echo signal, and the interference light signal; where coherent cancellation is performed on the phase-shifted local oscillator light signal and the interference light signal to eliminate the interference light signal, and frequency beating is performed on the local oscillator light signal after the coherent cancellation and the echo signal to generate a beat frequency signal; and
a detection unit, configured to receive the beat frequency signal provided by the coherent interference light rejection unit, and convert the beat frequency signal into an electrical signal.

It can be understood that by performing phase shifting on the local oscillator light and performing coherent process on the phase-shifted local oscillator light and the interference light signal, the lidar and the optical chip provided by embodiments of the present application are capable of eliminating the interference light signal, so as to eliminate the influence of the interference light signal on the echo signal in the lidar optical system, thereby improving the ranging precision of the lidar, and ensuring a normal operation of the lidar.

### BRIEF DESCRIPTION OF DRAWINGS

In order to more clearly illustrate the technical solutions in the embodiments of the present application, the accompanying drawings to be used in the description of the embodiments or prior art will be briefly introduced below, and it will be obvious that the accompanying drawings in the following description are only some of the embodiments of the present application, and that for a person of ordinary skill in the field, other accompanying drawings can be obtained according to these drawings without creative effort.

FIG. 1 is a structural schematic diagram of a lidar provided by an embodiment of the present application.

FIG. 2 is a schematic diagram of beam splitting processing performed on a laser signal by a beam splitter provided by an embodiment of the present application.

FIG. 3 is a structural schematic diagram of a coaxial lidar provided by an embodiment of the present application.

FIG. 4 is a schematic diagram of processing light signal by a circulator provided by an embodiment of the present application.

FIG. 5 is a structural schematic diagram of a parallel axis lidar provided by an embodiment of the present application.

FIG. 6 is a schematic diagram of processing light signal by a second coupler provided by an embodiment of the present application.

FIG. 7 is a schematic diagram of processing light signal by another second coupler provided by an embodiment of the present application.

FIG. 8 is a structural schematic diagram of an optical chip provided by an embodiment of the present application.

### DETAILED DESCRIPTION OF EMBODIMENTS

The technical solutions provided by embodiments of the present application are described below in combination with the accompanying drawings.

It should be understood that, in the description of embodiments of the present application, unless otherwise specified, “/” means or, for example, A/B may indicate either A or B. Herein, “and/or” is merely a description of an associated relationship of an associated object, indicating that there may be three kinds of relationships, for example, A and/or B, may denote: only A, both A and B, and only B.

In embodiments of the present application, the terms “first” and “second” are used for descriptive purposes only and are not to be understood as indicating or implying relative importance or implicitly specifying the number of technical features indicated. Accordingly, a feature defined with “first”, “second” may expressly or implicitly include one or more such features. In the description of this embodiment, unless otherwise specified, “more than one” means two or more.

Lidar is capable of detecting a target scanning area by laser signal scanning, determining parameters such as distance, orientation, height, speed, pose, and even shape of an object in the target scanning area, so as to monitor the target scanning area, therefore, it is widely applied in the fields of military, security, and surveying and mapping. In recent years, with the proliferation of intelligent devices such as automatic pilot, drones and robots, the demand for lidar has become increasingly urgent with stricter performance requirements.

Lidar includes Time of Fly (TOF) lidar and Frequency Modulated Continuous Wave (FMCW) lidar, where the TOF lidar is based on TOF technology ranging, and the FMCW lidar is based on FMCW technology. TOF ranging technology measures a distance of an obstacle based on a time of flight of the laser light. FMCW ranging technology modulates frequency of the laser light to be linear by frequency modulation techniques such as a triangular wave modulation or a ramp wave modulation, and determines a distance of an obstacle based on a frequency difference between an emitted light and a received light at the same moment. In some embodiments, taking an echo signal incident at the moment T as an example, since the frequency of the laser light of FMCW ranging technology varies linearly, the frequency of the detection light signal and that of the echo signal at the moment T are different. By measuring a frequency value of a frequency beating produced by coherence of the detection light signal and the received light, a distance to be measured can be calculated.

Compared to TOF ranging technology, FMCW ranging technology has a broader range of applications, such as non-contact surface analysis, fiber optic sensing, localization, tomography diagnosis etc. A very high interest in FMCW ranging technology is due to advantages of a large dynamic range, a high interference immunity, a very high detection sensitivity and a high accuracy of FMCW ranging, etc.

FMCW lidar includes parallel axis FMCW lidar and coaxial FMCW lidar. However, whether it is the parallel axis FMCW lidar or the coaxial FMCW lidar, the emitted light may produce a specific interference light signal in the lidar optical system. For example, for parallel axis FMCW lidar, light in a transmitting optical path may enter a receiving optical path by the crosstalk, thereby forming interference light signal in the receiving optical path and being detected. For the coaxial FMCW lidar, the emitted detection light signal and the received echo signal have identical optical paths in an optical transceiving unit, therefore, interference light signal caused by end-face reflection in the optical path may also be detected. Since FMCW lidar has extremely high detection sensitivity, if the emitted light produces interference light signal in the lidar optical system, the interference light signal will seriously interfere with the detection of an echo signal, resulting in an inaccurate lidar ranging, and even causing the lidar to fail to work.

To this end, embodiments of the present application provide a lidar, which is capable of eliminating a specific interference light signal generated within the lidar optical system, improving an accuracy of the FMCW lidar ranging, and ensuring a normal operation of the FMCW lidar.

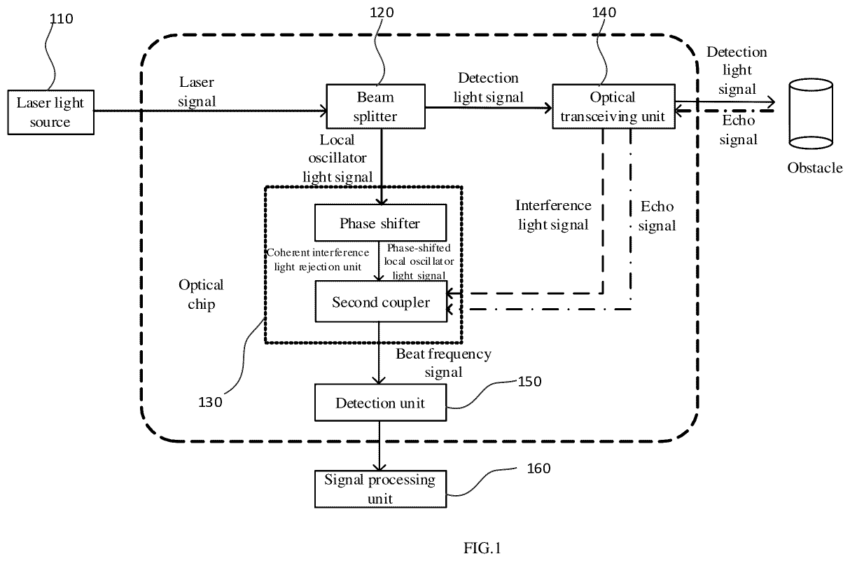

FIG. 1 is a structural schematic diagram of a lidar provided by an embodiment of the present application. Referring to FIG. 1, the FMCW lidar includes a laser light source 110, a beam splitter 120, a coherent interference light rejection unit 130; an optical transceiving unit 140, a detection unit 150 and a signal processing unit 160. The configuration and function of each component is described in detail below.

In the present embodiment, the laser light source 110 generates a laser signal, and provides the laser signal to the beam splitter 120. The beam splitter 120 is optically connected to the laser light source 110, receives the laser signal, splits the laser signal to form a local oscillator light signal and a detection light signal, provides the detection light signal to the optical transceiving unit 140, and provides the local oscillator light signal to the coherence interference light rejection unit 130. Next, the optical transceiving unit 140 transmits the received detection light signal to a detection space, receives an echo signal corresponding to the detection light signal in the detection space, and provides the echo signal and an interference light signal to the coherent interference light rejection unit 130, where the interference light signal is generated during transmission of the detection light signal by the optical transceiving unit 140. Then, the coherent interference light rejection unit 130 performs phase shifting on the local oscillator light signal to obtain a phase-shifted local oscillator light signal, and mixes the phase-shifted local oscillator light signal, the echo signal and the interference light signal, where the interference light signal will be eliminated by interfering with the phase-shifted local oscillator light signal. In an embodiment, coherent cancellation is performed on the phase-shifted local oscillator light signal and the interference light signal to eliminate the interference light signal, in other words, the interference light signal will be eliminated by interfering with the phase-shifted local oscillator light signal; frequency beating is performed on the local oscillator light signal after the coherent cancellation and the echo signal to generate a beat frequency signal, and the beat frequency signal will be provided to the detection unit, and converted into an electrical signal by the detection unit. Finally, related information of an obstacle is determined from the electrical signal by the signal processing unit electrically connected to the detection unit.

It can be understood that compared with prior art in which a local oscillator light signal is only used for frequency beating, in the present embodiment, first the phase shifting is performed on the local oscillator light signal, and then the phase-shifted local oscillator light signal is used for frequency beating with the interference light signal and the echo signal, where coherent cancellation is performed on the phase-shifted local oscillator light signal and the interference light signal to eliminate the interference light signal, and frequency beating is performed on the local oscillator light signal after the coherent cancellation and the echo signal to generate a beat frequency signal, thereby eliminating the influence of the interference light signal, improving an accuracy of the lidar ranging, and ensuring the lidar works properly.

In the some embodiments, the laser light source 110 is a frequency-modulated narrow linewidth laser light source for emitting a laser signal with a linewidth less than a preset linewidth (e.g. 10 MHz). It should be noted that the laser signal is frequency-modulated and that the frequency modulation is linear.

In the some embodiments, the beam splitter 120 may divide the laser signal into the detection light signal and the local oscillator light signal according to a preset ratio (e.g., 9:1, 99:1, etc.). Since both the detection light signal and the local oscillator light signal are obtained by beam splitting of the same laser signal, a pattern change of frequency of the detection light signal is consist with that of the local oscillator light signal, and a modulation frequency of the detection light signal and that of the local oscillator light signal frequency are linear.

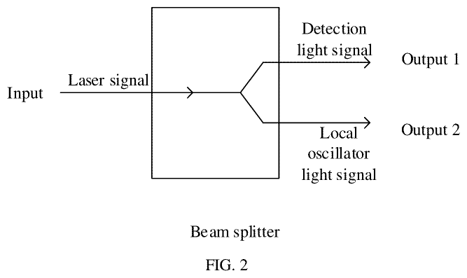

In some embodiments, referring to FIG. 2, the beam splitter 120 is a 1×2 optical coupler, i.e., the beam splitter includes one input and two outputs (e.g., output 1 and output 2). The input of the beam splitter is connected to an output of the laser light source 110 for receiving the laser signal. A first output of the beam splitter is connected to the optical transceiving unit for sending the detection light signal to the optical transceiving unit, and a second output of the beam splitter is connected to the coherent interference light rejection unit 130 for sending the local oscillator light signal to the coherent interference light rejection unit 130.

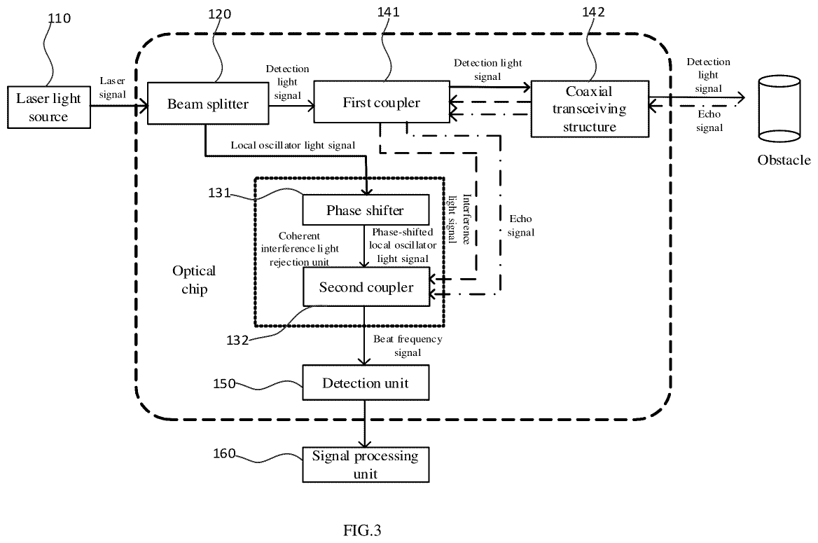

In some embodiments, the lidar is a coaxial FMCW lidar, and the optical transceiving unit 140 includes a first coupler 141 and a coaxial transceiving structure 142. Referring to FIG. 3, FIG. 3 shows the structure of a coaxial FMCW lidar. In the present embodiment, the first coupler 141 is optically connected to the beam splitter 120, the coherent interference light rejection unit 130 and the coaxial transceiving structure 142 respectively. The coaxial transceiving structure 142 receives the detection light signal provided by the beam splitter through the first coupler 141 and emits the detection light signal to the detection space. The coaxial transceiving structure 142 receives the echo signal and provides the echo signal and the interference light signal to the coherent interference light rejection unit through the first coupler, where the interference light signal is caused by an end-surface reflection of the detection light signal. It can be understood that since the transmitting optical path and the receiving optical path in the coaxial lidar are the same, the interference light signal will be transmitted to the detection unit via the receiving optical path, thereby causing interference to the echo signal.

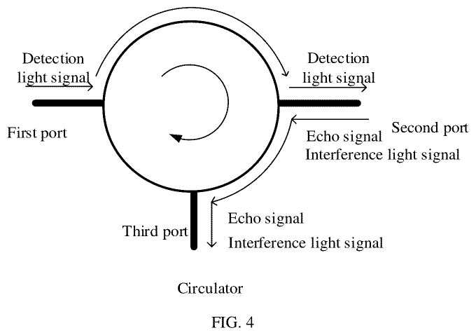

In the present embodiment, the first coupler 141 is configured to transmit the detection light signal to the coaxial transceiving structure 142, receive the echo signal and the interference light signal provided by the coaxial transceiving structure 142, and transmit the echo signal and the interference light signal to the coherent interference light rejection unit 130. Illustratively, referring to FIG. 4, the first coupler 141 may be an optical circulator including three ports, where a first port of the circulator is connected to the first output of the beam splitter, a second port of the circulator is connected to the coaxial transceiving structure, and a third port of the circulator is connected to the coherent interference light rejection unit 130. The circulator receives the detection light signal provided by the beam splitter through the first port thereof and transmits the detection light signal to the coaxial transceiving structure through the second port thereof. The circulator receives the echo signal and the interference light signal provided by the coaxial transceiving structure through the second port thereof, and provides the echo signal and the interference light signal to the coherent interference light rejection unit through the third port thereof. It should be understood that the first coupler may also be a device of other forms, for example, a combination of a polarization beam splitter rotator and a quarter-wave plate, a 2×2 coupler, etc.

The coaxial transceiving structure 142 is configured to transmit the detection light signal to the detection space and receive the echo signal formed by reflection of the detection light signal on a surface of the obstacle in the detection space. It should be noted that, in the coaxial transceiving structure, the emitting optical path of the detection light signal and the incident optical path of the echo signal are the same optical path. In addition, in the process of being emitted from the coaxial transceiving structure, the detection light signal will also be reflected by the internal structure of the coaxial transceiving structure, resulting in interference light signal. The interference light signal and the echo signal are transmitted to the coherent interference light rejection unit through the first coupler. Specifically, both the echo signal and the interference light signal sequentially enter the coherent interference light rejection unit through the second port and the third port of the first coupler 141.

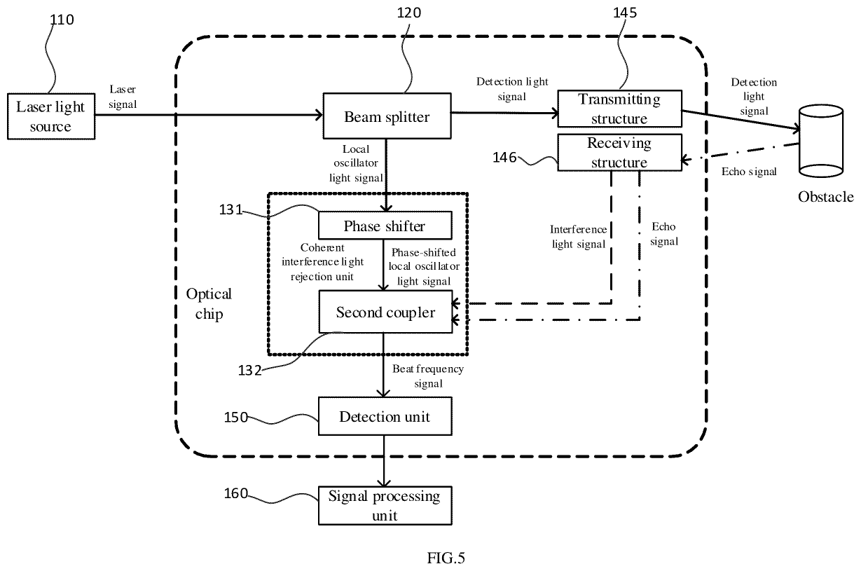

In some embodiments, the lidar is a parallel axis FMCW lidar, and the optical transceiving unit 140 includes a transmitting structure 143 and a receiving structure 144. Referring to FIG. 5, FIG. 5 shows a structure of a parallel axis lidar. In the present embodiment, the transmitting structure 143 receives the detection light signal provided by the beam splitter 120 and emits the detection light signal to the detection space, and the receiving structure 144 receives the echo signal and provides the echo signal and the interference light signal to the coherent interference light rejection unit, where the interference light signal includes light entering the receiving structure 144 by the crosstalk during transmission of the detection light signal by the transmitting structure 143. It can be understood that since a spacing between the transmitting structure 143 and the receiving structure 144 is relatively small, when the detection light signal is transmitted in the transmitting structure, part of the detection light signal may enter the receiving structure 144 by the crosstalk and be transmitted to the coherent interference light rejection unit together with the echo signal through the receiving structure, thereby affecting the accuracy of the ranging.

In some embodiments, the transceiving unit 140 includes devices or systems that can be used for optical transmission and reception, such as at least one optical antenna, or, at least one an optical phased array system. The optical antenna may be an optical transceiving in the form of an optical fiber, an optical transceiving in the form of an optical chip, or an optical transceiving in the form of a free-space lens set, etc., and in this embodiment, the specific form thereof is not limited thereto.

In other embodiments, the transceiving unit 140 may also be provided with an optical lens set that may include one or more optical lenses. The optical lens set can perform shaping on the detection light signal and the echo signal; where the shaping on the detection light signal includes collimating the emitted detection light signal so that light rays in the detection light signal can be emitted in parallel, and expanding the beam of the the collimated detection light signal; and the shaping on echo signal includes converging on the echo signal so as to reduce the size of the receiving light spot, thereby improving an effective receiving aperture of the optical transceiving unit to improve a receiving efficiency. However, it should be noted that, according to the principle of optical path reversibility, when the optical lens set transmits the detection light signal, it also reflects a part of the detection light signal, and the reflected detection light signal transmits along the original optical path. Some relatively strong echo signal form an interference light signal which is reflected back to the first coupler along the original optical path, and is transmitted to the coherent interference light rejection unit together with the echo signal. In other words, when the optical lens set is included in the optical transceiving unit, the interference light signal generated by the coaxial transceiving structure include not only the interference light signal generated in the transceiving optical path, but also the interference light signal generated due to reflection of the optical lens set.

The coherent interference light rejection unit 130 is optically connected to the beam splitter 120, the optical transceiving unit 140, and the detection unit 150. The coherent interference light rejection unit is configured to receive the local oscillator light signal provided by the beam splitter 120, perform phase shifting on the local oscillator light signal to obtain a phase-shifted local oscillator light signal, then perform coherent interference light rejection on the interference light signal by using the phase-shifted local oscillator light signal to eliminate the interference light signal, performing frequency beating on the coherent local oscillator light signal and the echo signal to generate a beat frequency signal, and send the beat frequency signal to the detection unit.

In some embodiments, the coherent interference light rejection unit 130 may include a phase shifter 131 and a second coupler 132. In an embodiment, the phase shifter 131 is optically connected to the beam splitter 120 for performing phase shifting on the local oscillator light signal, and a phase of the phase-shifted local oscillator light signal differs from a phase of the interference light signal by N×180 degrees, where N is an integer. The second coupler 132 is optically connected to the phase shifter 131, the optical transceiving unit 140, and the detection unit 150, respectively. The second coupler 132 is configured to receive the phase-shifted local oscillator light signal, the echo signal, and the interference light signal. The phase-shifted local oscillator light signal, the echo signal, and the interference light signal are mixed within the second coupler to eliminate the interference light signal, generate the beat frequency signal and send the beat frequency signal to the detection unit. Specifically, the phase-shifted local oscillator light signal and the interference light signal are coherently cancelled to eliminate the interference light signal, in other words, the interference light signal will be eliminated by interfering with the phase-shifted local oscillator light signal; and frequency beating is performed on the local oscillator light signal after the coherent cancellation and the echo signal to generate a beat frequency signal.

It should be noted that an optical distance difference between the local oscillator light signal and the interference light signal needs to be kept within a predetermined range, for example, the optical distances are equal or the optical distance difference is less than 10 cm. In the present embodiment, the optical distance refers to a distance travelled by the light signal (e.g., the local oscillator light signal, the interference light signal) as it is emitted from the laser light source and incident to the third optical coupler of the coherent interference light rejection unit.

Taking the local oscillator light signal as an example, in the FMCW coaxial lidar shown in FIG. 3, the optical distance of the local oscillator light signal may include: a length of an optical fiber between the laser light source 110 and the beam splitter 120, a distance travelled by the local oscillator light signal within the beam splitter, a length of an optical fiber/waveguide between the beam splitter 120 and the phase shifter 131, a distance travelled by the local oscillator light signal within the phase shifter 131, a length of the optical fiber/waveguide between the phase shifter 131 and the second coupler 132.

Taking the interference light signal as an example, since the interference light signal is generated from the detection light signal by reflection, the optical distance of the interference light signal includes not only an optical distance of the detection light signal from the laser light source 110 to the coaxial transceiving structure 142, but also a distance traveled by the interference light signal after the detection light signal is reflected by the coaxial transceiving structure to form the interference light signal. In other words, in combination with the structure shown in FIG. 3, the optical distance of the interference light signal includes: a length of the optical fiber between the laser light source 110 and the beam splitter 120, a distance traveled by the local oscillator light within the beam splitter 120, a length of the optical fiber/waveguide between the beam splitter 120 and the first coupler 141, a distance traveled by the detection light signal within the first coupler 141, a distance twice a length of the fiber/waveguide between the first coupler 141 and the coaxial transceiving structure 142, a distance traveled by the echo signal within the first coupler 141, and a length of the fiber/waveguide between the first coupler 141 and the second coupler 132.

Since both the detection light signal and the local oscillator light signal are a modulated light signal, their frequencies are linearly varied. Since the light speed is constant, when the optical distances of the local oscillator light signal and the interference light signal generated based on the detection light signal are within a preset range, it may be considered that the local oscillator light signal and the interference light signal have reached the second coupler after the same or a similar time. That is to say, the local oscillator light signal and the interference light signal are laser signals emitted at the same or similar moment by the laser light source, which have the same or a similar frequency, and are capable of being coherently cancelled.

When the phase difference between the phase of the phase-shifted local oscillator light signal and the phase of the interference light signal is an odd multiple of 180 degrees, the interference light signal and the phase-shifted local oscillator light signal produce destructive interference after mixing, such that the interference light signal basically disappears, and an amplitude of the local oscillator light signal is reduced. When the phase difference between the phase of the phase-shifted local oscillator light signal and the phase of the interference light signal is an even multiple of 180 degrees, the interference light signal and the local oscillator light signal produce constructive interference after mixing, and the interference light signal becomes a local oscillator light signal, such that an amplitude of the local oscillator light signal rises.

It can be understood that since during mixing of the phase-shifted local oscillator light signal, the echo signal and the interference light signal, the phase-shifted local oscillator light signal is capable of eliminating the interference light signal, thus the beat frequency signal is generated by frequency beating of the coherent local oscillation light signal and the echo signal.

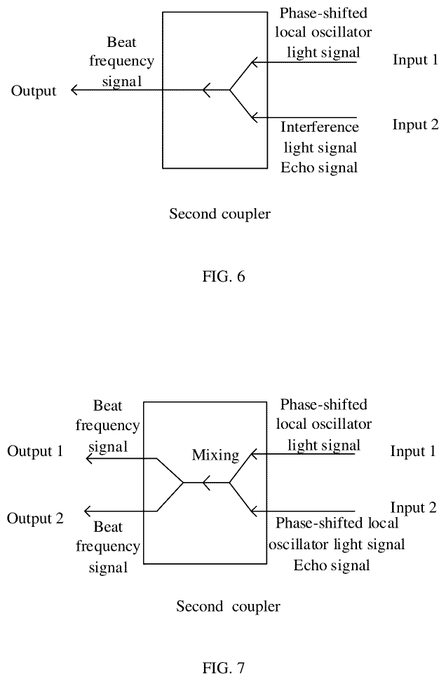

In some embodiments, referring to FIG. 6, the second coupler 132 may be a 2×1 optical coupler, i.e., this second coupler is provided with two inputs and one output. The two inputs of the second coupler are connected to the output of the phase shifter and the third port of the first coupler, respectively. In an embodiment, the input of the second coupler connected to the output of the phase shifter is configured to receive the phase-shifted local oscillator light signal, and the input of the second coupler connected to the third port of the first coupler is configured to receive the echo signal and the interference light signal. The output of the second coupler is connected to the detection unit. The phase-shifted local oscillator light signal, the echo signal and the interference light signal form the beat frequency signal after mixing in the second coupler, and the beat frequency signal is output to the detection unit through the output of the second coupler.

In other embodiments, referring to FIG. 7, the second coupler 132 may be a 2×2 optical coupler (which may be understood as a combination of a 2×1 optical coupler and a 1×2 optical coupler) provided with two inputs and two outputs. The two inputs of the 2×2 optical coupler are connected to the output of the phase shifter and to the third port of the first coupler, respectively. In an embodiment, the input of the second coupler 132 connected to the output of the phase shifter is configured to receive the phase-shifted local oscillator light signal, and the input of the second coupler 132 connected to the third port of the first coupler is configured to receive the echo signal and the interference light signal. The two outputs of the 2×2 optical coupler are connected to different inputs of the detection unit. In the second coupler, the beat frequency signal is formed by mixing the phase-shifted local oscillator light signal, the echo signal and the interference light signal, and is divided into two signals for outputting to the detection unit.

The detection unit 150 is configured to convert the beat frequency signal into an electrical signal.

In some embodiments, the detection unit 150 is a single-ended detector, i.e., the detection unit has only one input. The single-ended detection unit is used in combination with a 2×1 second optical coupler to receive the beat frequency signal from a single output of the second coupler, i.e. the second coupler combines the beat frequency signal into one signal for inputting into the detector.

In some embodiments, the detection unit 150 is a balanced detector, i.e., the balanced detector has two inputs. The balanced detector is used in combination with a 2×2 beam splitter and receives the beat frequency signal from a dual output of the second coupler, i.e. the second coupler splits the beat frequency signal into two signals for inputting into the detector.

The signal processing unit 160 may be a circuit module with logic operation capability such as a microcontroller, a digital signal processor (DSP), or a Field-Programmable Gate Array (FPGA). The signal processing unit is configured to determine the related information of the obstacle according to the electrical signal sent by the detection unit. The related information of the obstacle includes at least one of distance information, speed information, orientation information, height information, pose information, and shape information.

The working process of the coaxial lidar provided by embodiments of the present application is described in detail below in combination with the structure shown in FIG. 3.

After the lidar is energized, the laser light source 110 generates a laser signal and emits the laser signal to the beam splitter 120, and the laser signal is divided into a beam of detection light signal and a beam of local oscillator light by the beam splitter. The local oscillator light passes through a phase shifter and then enters a second coupler of the coherent interference light rejection unit. The detection light signal enters a coaxial transceiving structure after passing through a first coupler, and is emitted through the coaxial transceiving structure. The detection light signal may generate an interference light signal due to end-face reflection in the process of emitting. The detection light signal returns to the coaxial transceiving structure in the form of an echo signal when it encounters an obstacle after emitting, and the returned echo signal and the interference light signal together pass through the first coupler and enter the second coupler in the coherent interference light rejection unit. In the second coupler, the phase-shifted local oscillator light signal, the echo signal and the interference light signal are combined. Specifically, coherent cancellation is performed on the phase-shifted local oscillator light signal and the interference light signal to eliminate the interference light signal, and frequency beating is performed on the local oscillator light signal after the coherent cancellation and the echo signal to generate a beat frequency signal, which is sent to a detection unit. The detection unit converts the beat frequency signal into an electrical signal, and then sends the electrical signal to a signal processing unit for processing to determine related information of the obstacle, such as the distance, speed, and direction of movement of the obstacle.

In summary, the lidar provided by the embodiments of the present application is capable of eliminating the influence of the interference light signal on the echo signal in a lidar optical system, improving the ranging precision of the lidar, and ensuring the lidar works properly by performing phase shifting on the local oscillator light and performing coherent process with the phase-shifted local oscillator light signal and the interference light signal.

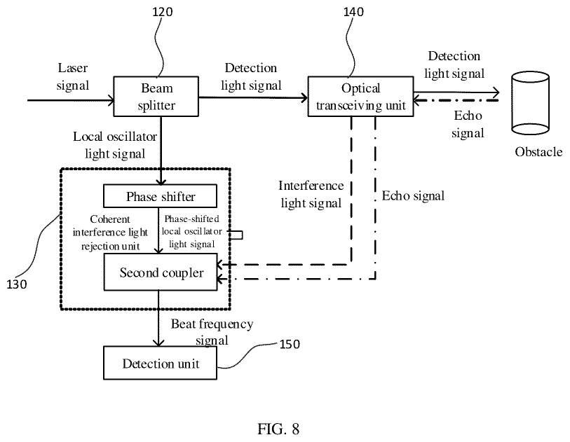

Embodiments of the present application also provide an optical chip. Referring to FIG. 8, the optical chip includes a beam splitter 120, an optical transceiving unit 140, a coherent interference light rejection unit 130, and a detection unit 150.

In an embodiment, the beam splitter 120 is configured to receive a laser signal and divide the laser signal into a detection light signal and a local oscillator light signal. The laser signal may be provided by a laser light source independent of the optical chip. Accordingly, the optical chip is provided with an input coupler, and the laser light source sends the laser signal to the input coupler via an optical fiber, through which the laser signal is coupled to the chip and provided to the beam splitter.

The optical transceiving unit 140 is optically connected to the beam splitter 120 and the coherent interference light rejection unit 130, respectively, and is configured to receive the detection light signal provided by the beam splitter, transmit the detection light signal to a detection space, and receive an echo signal corresponding to the detection light signal; where the optical transceiving unit may generate an interference light signal during transmission of the detection light signal.

The coherent interference light rejection unit 130 is configured to perform phase shifting on the local oscillator light signal, and mix the phase-shifted local oscillator light signal, the echo signal, and the interference light signal, where coherent cancellation is performed on the phase-shifted local oscillator light signal and the interference light signal to eliminate the interference light signal, and frequency beating is performed on the local oscillator light signal after the coherent cancellation and the echo signal to generate a beat frequency signal. In the present embodiment, the coherent interference light rejection unit 130 may include a phase shifter 131 and a second coupler 132, where the phase shifter is configured to perform phase shifting on the received local oscillator light signal, and the second coupler 132 is configured to mix the phase-shifted local oscillator light signal and the interference light signal to eliminate the interference light signal and generate the beat frequency signal.

The detection unit 150 is configured to receive the beat frequency signal provided by the coherent interference light rejection unit 130, and convert the beat frequency signal into an electrical signal. In the present embodiment, the detection unit 150 is optically connected to the second coupler 132. The detection unit may be a single-ended detector or a balanced detector, and details may be referred to above, which will not be described herein.

In an embodiment, the beam splitter 120, the coherent interference light rejection unit 130, the optical transceiving unit 140, and the detection unit 150 may be integrated on a silicon optical chip, and the specific configurations and functions of the individual devices thereof, etc., may refer to the preceding description, which will not be repeated herein.

In some embodiments, a phase of the phase-shifted local oscillator light signal differs from a phase of the interference light signal by N×180 degrees, where N is an integer. It can be understood that when the phase difference between the phase of the phase-shifted local oscillator light signal and the phase of the interference light signal is an odd multiple of 180 degrees, the interference light signal and the phase-shifted local oscillator light signal produce destructive interference after mixing, such that the interference light signal basically disappears, and an amplitude of the local oscillator light signal is reduced. When the phase difference between the phase of the phase-shifted local oscillator light signal and the phase of the interference light signal is an even multiple of 180 degrees, the interference light signal and the local oscillator light signal produce constructive interference after mixing, and the interference light signal becomes a local oscillator light signal, such that an amplitude of the local oscillator light signal rises. It should also be noted that the optical distance difference between the local oscillator light signal and the interference light signal needs to be kept within a preset range.

In some embodiments, referring to FIG. 3 again, the optical transceiving unit 140 includes a first coupler 141 and a coaxial transceiving structure 142. In the present embodiment, the first coupler 141 is optically connected to the beam splitter 120, the coherent interference light rejection unit 130 and the coaxial transceiving structure 142 respectively. The coaxial transceiving structure 142 receives the detection light signal provided by the beam splitter through the first coupler 141 and emits the detection light signal to the detection space. The coaxial transceiving structure receives the echo signal and provides the echo signal and the interference light signal to the detection unit through the first coupler, where the interference light signal is caused by end-face reflection of the detection light signal. It can be understood that since the transmitting optical path and the receiving optical path in the coaxial lidar are the same, the interference light signal will be transmitted to the detection unit via the receiving optical path, thereby causing interference to the echo signal.

In some embodiments, referring to FIG. 5, the optical transceiving unit 140 includes a transmitting structure 143 and a receiving structure 144. In the present embodiment, the transmitting structure 143 receives the detection light signal provided by the beam splitter 120 and emits the detection light signal to the detection space, and the receiving structure 144 receives the echo signal and provides the echo signal and the interference light signal to the coherent interference light rejection unit, where the interference light signal includes light entering the receiving structure by the crosstalk during transmission of the detection light signal by the transmitting structure. It can be understood that since a spacing between the transmitting structure and the receiving structure is relatively small, when the detection light signal is transmitted in the transmitting structure, part of the detection light signal may enter the receiving structure by the crosstalk and be transmitted to the coherent interference light rejection unit together with the echo signal through the receiving structure, thereby affecting the accuracy of the ranging.

It should be noted that the optical chip provided by the embodiments of the present application can be applied not only to FMCW lidar, but also to other devices using FMCW ranging technology, and the application scenario of the optical chip is not limited thereto.

Referring to the preceding description, it can be seen that when the optical chip provided in the embodiments of the present application is applied for FMCW lidar ranging, the optical chip is capable of eliminating the adverse effect of the interference light signal on the echo signal in the lidar optical system and improving the ranging precision by performing phase shifting on the local oscillator light and performing coherent process with the phase-shifted local oscillator light signal and the interference light signal.

It should be understood that, when used in the specification and the appended claims of the present application, the term “including” indicates the presence of the described features, integrals, steps, operations, elements and/or components, but does not exclude the presence of, or addition of, one or more other features, integrals, steps, operations, elements, components, and/or collections thereof. Referring to “an embodiment” or “some embodiments” etc., described

in the specification of the present application means that one or more embodiments of the present application include particular features, structures or characteristics described in combination with the embodiment. Accordingly, the phrases “in one (or an) embodiment”, “in some embodiments”, etc., which appear in different places in this specification do not necessarily refer to the same embodiment, but mean “one or more but not all embodiments”, unless otherwise specifically emphasized. The terms “including”, “containing”, “having” and variations thereof mean “including but not limited to” unless otherwise specifically emphasized.

The above-described embodiments are configured to illustrate the technical solutions of the present application only, and are not intended to be limiting. Although the present application has been described in detail with reference to the above-described embodiments, a person of ordinary skill in the art should understand that it is still possible to make modifications to the technical solutions as recorded in the foregoing embodiments, or to make equivalent substitutions for some of the technical features therein. These modifications or substitutions do not detach the essence of the corresponding technical solutions from the spirit and scope of the technical solutions of the embodiments of the present application, and should be included in the scope of protection of the present application.

What is claimed is:

1. A lidar, comprising:
a laser light source configured to generate a laser signal;
a beam splitter configured to receive the laser signal and divide the laser signal into a detection light signal and a local oscillator light signal;
an optical transceiving unit configured to receive the detection light signal provided by the beam splitter, transmit the detection light signal to a detection space, and receive an echo signal corresponding to the detection light signal, wherein the optical transceiving unit generates an interference light signal during transmission of the detection light signal;
a coherent interference light rejection unit configured to perform phase shifting on the local oscillator light signal, and mix a phase-shifted local oscillator light signal, the echo signal, and the interference light signal, wherein coherent cancellation is performed on the phase-shifted local oscillator light signal and the interference light signal to eliminate the interference light signal, and frequency beating is performed on the local oscillator light signal after the coherent cancellation and the echo signal to generate a beat frequency signal;
a detection unit configured to receive the beat frequency signal provided by the coherent interference light rejection unit, and convert the beat frequency signal into an electrical signal; and
a signal processing unit connected to the detection unit, and configured to determine related information of an obstacle according to the electrical signal.

2. The lidar according to claim 1, wherein the coherent interference light rejection unit comprises:
a phase shifter, optically connected to the beam splitter, and configured to receive the local oscillator light signal and perform phase shifting on the local oscillator light signal; and
a second coupler, optically connected to the phase shifter, the optical transceiving unit, and the detection unit, respectively, and configured to receive the phase-shifted local oscillator light signal, the echo signal, and the interference light signal, and the phase-shifted local oscillator light signal, the echo signal, and the interference light signal are combined within the second coupler to eliminate the interference light signal and generate the beat frequency signal.

3. The lidar according to claim 1, wherein a phase of the phase-shifted local oscillator light signal differs from a phase of the interference light signal by N×180 degrees, wherein N is an integer.

4. The lidar according to claim 1, wherein the optical transceiving unit comprises a first coupler and a coaxial transceiving structure; and
wherein the coaxial transceiving structure receives the detection light signal provided by the beam splitter through the first coupler and emits the detection light signal to the detection space, and the coaxial transceiving structure receives the echo signal and provides both the echo signal and the interference light signal to the coherent interference light rejection unit through the first coupler; and the interference light signal is caused by an end-surface reflection of the detection light signal.

5. The lidar according to claim 1, wherein the optical transceiving unit comprises a transmitting structure and a receiving structure;
wherein the transmitting structure receives the detection light signal provided by the beam splitter and emits the detection light signal to the detection space, and the receiving structure receives the echo signal and provides the echo signal and the interference light signal to the coherent cancellation unit coherent interference light rejection unit; and wherein the interference light signal comprises light entering the receiving structure by crosstalk during the transmission of the detection light signal by the transmitting structure.

6. The lidar according to claim 1, wherein, when the detection unit is a single-ended detector, the second coupler combines the beat frequency signal into one signal for inputting into the detector; and
when the detection unit is a balanced detector, the second coupler splits the beat frequency signal into two signals for inputting into the detector.

7. The lidar according to claim 1, wherein the laser light source is a narrow linewidth laser light source, and a linewidth of the laser signal emitted by the narrow linewidth laser light source is less than 10 MHz.

8. The lidar according to claim 1, wherein the related information of the obstacle comprises at least one of distance information, speed information, orientation information, height information, pose information, and shape information.

9. The lidar according to claim 1, wherein the transceiving unit comprises at least one optical antenna, or at least one optical phased array system.

10. The lidar according to claim 1, wherein the transceiving unit further comprises an optical lens set configured to perform collimating and expanding on the detection light signal, and perform converging on the echo signal.

11. The lidar according to claim 2, wherein the beam splitter, the coherent interference light rejection unit, the optical transceiving unit, and the detection unit are integrated on an optical chip.

12. The lidar according to claim 2, wherein a phase of the phase-shifted local oscillator light signal differs from a phase of the interference light signal by N×180 degrees, wherein N is an integer.

13. An optical chip, comprising:
a beam splitter configured to receive a laser signal and divide the laser signal into a detection light signal and a local oscillator light signal;
an optical transceiving unit configured to receive the detection light signal provided by the beam splitter, transmit the detection light signal to a detection space, and receive an echo signal corresponding to the detection light signal, wherein the optical transceiving unit generates an interference light signal during transmission of the detection light signal;
a coherent interference light rejection unit configured to perform phase shifting on the local oscillator light signal, and mix a phase-shifted local oscillator light signal, the echo signal, and the interference light signal, wherein coherent cancellation is performed on the phase-shifted local oscillator light signal and the interference light signal to eliminate the interference light signal, and frequency beating is performed on the local oscillator light signal after the coherent cancellation and the echo signal to generate a beat frequency signal; and
a detection unit configured to receive the beat frequency signal provided by the coherent interference light rejection unit, and convert the beat frequency signal into an electrical signal.

14. The optical chip according to claim 13, wherein a phase of the phase-shifted local oscillator light signal differs from a phase of the interference light signal by N×180 degrees, wherein N is an integer.

15. The optical chip according to claim 13, wherein the optical transceiving unit comprises a first coupler and a coaxial transceiving structure;
wherein the coaxial transceiving structure receives the detection light signal provided by the beam splitter through the first coupler and emits the detection light signal to the detection space, and the coaxial transceiving structure receives the echo signal and provides both the echo signal and the interference light signal to the coherent interference light rejection unit through the first coupler; and the interference light signal is caused by an end-surface reflection of the detection light signal.

16. The optical chip according to claim 14, wherein the optical transceiving unit comprises a transmitting structure and a receiving structure; and
wherein the transmitting structure receives the detection light signal provided by the beam splitter and emits the detection light signal to the detection space, and the receiving structure receives the echo signal and provides the echo signal and the interference light signal to the coherent interference light rejection unit; and wherein the interference light signal comprises light entering the receiving structure by crosstalk during the transmission of the detection light signal by the transmitting structure.

17. The optical chip according to claim 13, wherein, when the detection unit is a single-ended detector, the second coupler combines the beat frequency signal into one signal for inputting into the detector; and
when the detection unit is a balanced detector, the second coupler splits the beat frequency signal into two signals for inputting into the detector.

18. The optical chip according to claim 13, wherein the laser light source is a narrow linewidth laser light source, and a linewidth of the laser signal emitted by the narrow linewidth laser light source is less than 10 MHz.

19. The optical chip according to claim 13, wherein the related information of the obstacle comprises at least one of distance information, speed information, orientation information, height information, pose information, and shape information.

20. The optical chip according to claim 13, wherein the transceiving unit comprises at least one optical antenna, or at least one optical phased array system.
